(19) United States
(12) Patent Application Publication
(10) Pub. No.: US 2019/0230618 A1
(43) Pub. Date: Jul. 25, 2019

(54) USING SIDELINK INFORMATION IN RADIO-BASED POSITIONING

(71) Applicant: NOKIA TECHNOLOGIES OY, Espoo (FI)

(72) Inventors: Stephan SAUR, Stuttgart (DE); Silvio MANDELLI, Tamm (DE); Howard HUANG, New York, NY (US); Juergen OTTERBACH, Stuttgart (DE)

(21) Appl. No.: 15/878,024

(22) Filed: Jan. 23, 2018

(51) Int. Cl. H04W 64/00; H04W 56/00; H04L 5/00; G01S 5/14; G01S 5/02

(52) U.S. Cl. CPC H04W 64/003; H04W 56/001; H04W 72/048; G01S 5/14; G01S 5/0226; H04L 5/0048

(57) ABSTRACT

Various communication systems may benefit from improved positioning estimation. For example, certain embodiments may benefit from improved radio-based positioning estimation of a target user equipment using an observed time difference of arrival. A method, in certain embodiments, may include receiving at a target user equipment from a network entity a list comprising a plurality of supporting user equipment and a plurality of base stations. The method may also include receiving at the target user equipment supporting positioning reference signals via sidelink transmission from the plurality of supporting user equipment and positioning reference signals from the plurality of base stations. In addition, the method may include taking observed time difference of arrival measurements or determining a position estimate at the target user equipment based on the positioning reference signals and the supporting positioning reference signals.

### BACKGROUND

### Field

Various communication systems may benefit from improved positioning estimation. For example, certain embodiments may benefit from improved radio-based positioning estimation of a target user equipment using an observed time difference of arrival.

### Description of the Related Art

Third Generation Partnership Project (3GPP), as well as other standard bearing organizations, have focused on providing an accurate position measurement of a user equipment (UE). 3GPP technology, such as Long Term Evolution (LTE), LTE-A, and New Radio (NR) or 5^{th} Generation (5G) technology, place an increased importance on sub-meter positioning accuracy of the UE. Increasing the positioning accuracy of a UE can help to protect vulnerable road users (VRUs), such as pedestrians, wheelchairs, and cyclists, from vehicles, specifically autonomously driving vehicles. Protection of VRUs requires accurate positioning of both the vehicle and the VRU.

Global Navigation Satellite Systems (GNSS) that utilize a Global Positioning System (GPS) are used to determine the positioning of the UE. Although GPS works well in open areas with a line-of-sight to a sufficiently large number of satellites, when the line-of-sight is hindered using the GPS may be limited or even excluded. Some locations in which line-of-sight is hindered, thereby limiting the usefulness of the GPS, may include tunnels, under bridges, parking garages, next to buildings, or under dense foliage. Quality of Service (QoS) for VRU protection in such circumstances cannot be ensured using GPS technology.

Position estimation can also be performed using cellular access technology, such as LTE. There are many impairments that prevent achieving positional accuracy using cellular access technology. For example, there may be unresolvable multi-path and non-line-of-sight (NLOS) propagation, such as falsification of positioning measurements due to reflection, diffraction, scattering, and blocking. There may also be insufficient synchronization between base stations, an insufficient number of hearable base stations in the area of interest, and/or disadvantageous geometry between the UE being measured and the base station sending out Positioning Reference Signals (PRSs). Hearable means that the received signal strength is high enough for a meaningful measurement of that signal.

### SUMMARY

According to certain embodiments, an apparatus may include at least one memory including computer program code, and at least one processor. The at least one memory and the computer program code may be configured, with the at least one processor, to cause the apparatus at least to receive from a network entity a list comprising a plurality of supporting user equipment and a plurality of base stations. The at least one memory and the computer program code may also be configured, with the at least one processor, to cause the apparatus at least to receive supporting positioning reference signals via sidelink transmission from the plurality of supporting user equipment and positioning reference signals from the plurality of base stations. In addition, the at least one memory and the computer program code may be configured, with the at least one processor, to cause the apparatus at least to take an observed time difference of arrival measurements or determine a position estimate based on the positioning reference signals and the supporting positioning reference signals.

A method, in certain embodiments, may include receiving at a target user equipment from a network entity a list comprising a plurality of supporting user equipment and a plurality of base station. The method may also include receiving at the target user equipment supporting positioning reference signals via sidelink transmission from the plurality of supporting user equipment and positioning reference signals from the plurality of base stations. In addition, the method may include taking an observed time difference of arrival measurements or determining a position estimate at the target user equipment based on the positioning reference signals and the supporting positioning reference signals.

An apparatus, in certain embodiments, may include means for receiving from a network entity a list comprising a plurality of supporting user equipment and a plurality of base stations. The apparatus may also include means for receiving supporting positioning reference signals via sidelink transmission from the plurality of supporting user equipment and positioning reference signals from the plurality of base stations. In addition, the apparatus may include means for taking an observed time difference of arrival measurements or determining a position estimate based on the positioning reference signals and the supporting positioning reference signals.

According to certain embodiments, a non-transitory computer-readable medium encoding instructions that, when executed in hardware, perform a process. The process may include receiving at a target user equipment from a network entity a list comprising a plurality of supporting user equipment and a plurality of base stations. The process may also include receiving at the target user equipment supporting positioning reference signal via a sidelink from the supporting user equipment and a positioning reference signal from the base station. In addition, the process may include taking an observed time difference of arrival measurement or determining a position estimate at the target user equipment based on the positioning reference signal and the supporting positioning reference signal.

According to certain other embodiments, a computer program product may encode instructions for performing a process. The process may include receiving at a target user equipment from a network entity a list comprising of supporting user equipment and a base station. The process may also include receiving at the target user equipment a supporting positioning reference signal via a sidelink from the plurality of supporting user equipment and positioning reference signals from the plurality of base stations. In addition, the process may include taking an observed time difference of arrival measurements or determining a position estimate at the target user equipment based on the positioning reference signals and the supporting positioning reference signals.

According to certain embodiments, an apparatus may include at least one memory including computer program code, and at least one processor. The at least one memory and the computer program code may be configured, with the at least one processor, to cause the apparatus at least to transmit to a target user equipment a list comprising of a plurality of supporting user equipment and a plurality of base stations. The at least one memory and the computer program code may also be configured, with the at least one processor, to cause the apparatus at least to schedule uplink resources for transmission of supporting positioning reference signals via sidelink transmission by the plurality of supporting user equipment and transmission of positioning reference signals by the plurality of base stations. In addition, the at least one memory and the computer program code may be configured, with the at least one processor, to cause the apparatus at least to compute at least one set of observed time difference of arrival measurements or a position estimate from the target user equipment. The observed time difference of arrival measurement or the position estimate may be based on the supporting positioning reference signals and the positioning reference signals.

A method, in certain embodiments, may include transmitting from a network entity to a target user equipment a list comprising a plurality of supporting user equipment and a plurality of base stations. The method may also include scheduling uplink resources for transmission of supporting positioning reference signals via sidelink transmission by the plurality of supporting user equipment and transmission of positioning reference signals by the plurality of base stations. In addition, the method may include computing at the network entity observed time difference of arrival measurements or a position estimate from the target user equipment. The observed time difference of arrival measurements or the position estimate may be based on the supporting positioning reference signals and the positioning reference signals.

An apparatus, in certain embodiments, may include means for transmitting from a network entity to a target user equipment a list comprising a plurality of supporting user equipment and a plurality of base stations. The apparatus may also include means for scheduling uplink resources for transmission of supporting positioning reference signals via sidelink transmission by the plurality of supporting user equipment and transmission of positioning reference signals by the plurality of base stations. In addition, the apparatus may include means for computing at the network entity observed time difference of arrival measurements or a position estimate from the target user equipment. The observed time difference of arrival measurements or the position estimate may be based on the supporting positioning reference signals and the positioning reference signals.

According to certain embodiments, a non-transitory computer-readable medium encoding instructions that, when executed in hardware, perform a process. The process may include transmitting from a network entity to a target user equipment a list comprising a plurality of supporting user equipment and a plurality of base stations. The process may also include scheduling uplink resources for transmission of supporting positioning reference signals via sidelink transmission by the plurality of supporting user equipment and transmission of positioning reference signals by the plurality of base stations. In addition, the process may include computing at the network entity observed time difference of arrival measurements or a position estimate from the target user equipment. The observed time difference of arrival measurements or the position estimate may be based on the supporting positioning reference signals and the positioning reference signals.

According to certain other embodiments, a computer program product may encode instructions for performing a process. The process may transmitting from a network entity to a target user equipment a list comprising a plurality of supporting user equipment and a plurality of base stations. The process may also include scheduling uplink resources for transmission of supporting positioning reference signals via sidelink transmission by the plurality of supporting user equipment and transmission of positioning reference signals by the plurality of base stations. In addition, the process may include computing at the network entity observed time difference of arrival measurements or a position estimate from the target user equipment. The observed time difference of arrival measurements or the position estimate may be based on the supporting positioning reference signals and the positioning reference signals.

### BRIEF DESCRIPTION OF THE DRAWINGS

For proper understanding of the invention, reference should be made to the accompanying drawings, wherein:

FIG. 1 illustrates an example of a diagram according to certain embodiments.

FIG. 2 illustrates an example of a signal flow diagram according to certain embodiments.

FIG. 3 illustrates an example of a diagram according to certain embodiments.

FIG. 4 illustrates an example of a flow diagram according to certain embodiments.

FIG. 5 illustrates an example of a flow diagram according to certain embodiments.

FIG. 6 illustrates an example of a system according to certain embodiments.

### DETAILED DESCRIPTION

Certain embodiments may complement base stations (BSs) sending PRS in the downlink to a UE, such as a target UE (T-UE), with a set of supporting UEs (S-UEs) sending additional support PRSs (S-PRS) to a T-UE on a sidelink resource. Adding the S-UEs, which send the additional S-PRS to the T-UE, may help to minimize the Geometrical Dilution of Precision (GDOP) of the T-UE. The available useful number of Observed Time Difference of Arrivals (OTDOA) measurements taken at the T-UE may be adjusted or changed according to a QoS level. In certain embodiments, S-PRS may be transmitted to coincide with uplink transmissions. For example, in a Frequency Division Duplex (FDD) system, S-PRS transmissions may occur on uplink spectral resources, while in Time Division Duplex (TDD) systems, S-PRS transmissions may occur during uplink time resources. The S-PRS transmissions may be scheduled by a network entity to minimize interference between the S-UEs and the BSs.

An insufficient number of hearable base stations may cause a bad performance of the multilateration algorithm, which may be used to determine the UE position. The algorithm may depend on a set of OTDOA measurements with a Maximum Likelihood (ML) or a Maximum-A-Posteriori (MAP) estimator. In some embodiments, three base stations, which provide for two OTDOA measurements, may suffice for 2D-positioning. 2D-positioning may be defined based on Cartesian x-y coordinates or latitude and longitude coordinates. Each additional available measurement, however, decreases the area that may be characterized by a high probability that the true location falls within the area. In other words, the positioning error decreases with increasing number of hearable base stations. Because the number of base stations are fixed, there may be areas or locations where the positioning QoS requirements cannot be fulfilled, leading to a lack of accurate positioning estimation.

The problem of disadvantageous geometry may be referred to as a GDOP. The GDOP is small when the UE position is the center of an equatorial triangle, which a different base station acting as a different vertex of the triangle. When the UE moves towards one of the edges of the triangle, or even crosses the edge, the GDOP may increase significantly. As the standard deviation of the multilateration-based positioning is proportional to the GDOP, the positioning error increases significantly as the UE moves away from the center. Since the positions of the base stations are fixed, while the UEs are moving, the GDOP, and consequently the positioning accuracy, may vary over time, which makes it difficult to guarantee a ubiquitous QoS standard for positional accuracy.

To help improve positional accuracy of the T-UE, certain embodiments may utilize a set of S-UEs sending S-PRSs to the T-UE via sidelink resources. Sidelink transmissions may be device-to-device transmissions, also known as direct transmissions, between the S-UE and the T-UE. The S-PRS transmitted via the sidelink may utilize an uplink resource. The S-UEs sending S-PRSs to the T-UE may help to increase the number of OTDOA measurements performed by the T-UE. The number of increased measurements may help to minimize the GDOP of the T-UE, and maintain an accurate positioning estimate of the T-UE.

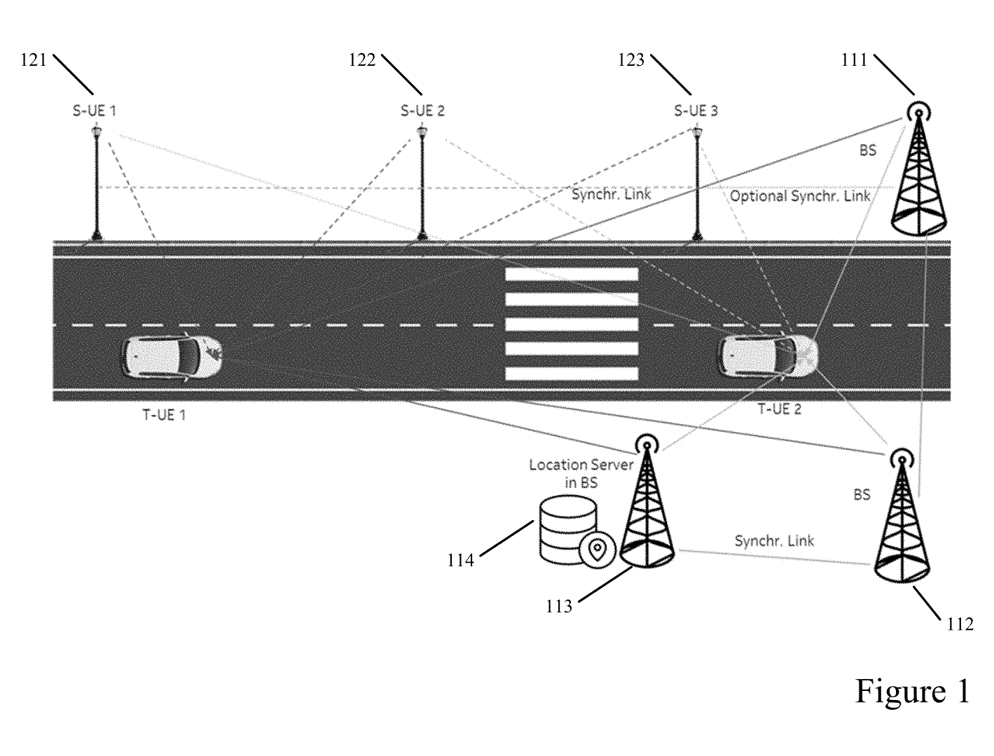

FIG. 1 illustrates an example of a diagram according to certain embodiments. In particular, FIG. 1 illustrates a system for determining radio-based positioning accuracy that includes S-UEs 121, 122, 123, BSs 111, 112, 113, and a location server (LS) 114. In certain embodiments, a location server may be referred to as a network entity. The example shown in FIG. 1 illustrates sidelink connections or bearers between the S-UEs and the T-UE, which allow for an increased number of OTDOA measurements.

LS 114, in certain embodiments, may configure S-PRS transmission from the S-UEs. The configuration may be based on the QoS requirements of the T-UE. When the T-UE moves away from a given S-UE, LS 114 may disassociate the T-UE from the given S-UE. In addition, LS 114 may not associate some S-UEs or BSs with a T-UE because the S-UEs or BSs may be located too far, causing the confidence of the measurements received from those distant S-UEs and BSs to be low. Overall, LS 114 may aim to minimize the GDOP for the T-UE.

Location server 114 may orchestrate a positioning algorithm for the T-UE. Location server 114, in some embodiments, may be located in a base station, such as BS 113, while in other embodiments location server 114 may be an application run on a remote server. The remote server may be part of a distributed cloud technology. As can be seen in FIG. 1, BSs 111, 112, and 113 are static, and their positions may be known by the system and calibrated accordingly. In certain embodiments, location server 114 may maintain a list of S-UEs, such as S-UE1 121, S-UE2 122, and S-UE3 123, which may transmit S-PRS to support T-UE localization. The position of the S-UEs may be known at location server 114 with high precision. In other words, the S-UEs may be static, meaning that the S-UEs have a fixed position. S-UEs may be user devices that require little or no human interaction, such as a meter, sensor, or actuator. The meter, sensor, or actuator may be placed in a static apparatus, such as a lamp, a parking meter, a traffic light, a stop sign, or a Road Side Unit (RSU).

In certain embodiments, the S-UEs in a system may be synchronized amongst themselves, or amongst a subset of the S-UEs. The S-UEs may also be synchronized with the base stations, or any other network entities included in the network. Synchronization of the S-UEs may help to produce meaningful OTDOA measurements using sidelink transmissions. For every subset of N synchronized S-UEs or BSs, N−1 OTDOA measurement may be taken or produced. FIG. 1 illustrates a synchronization link located between BS 113 and BS 112, as well as a synchronization link between BS 112 and BS 111. As such, the BSs themselves must be synchronized amongst one another. In addition, FIG. 1 illustrates a synchronization link, referred to as an optional synchronization link between BS 111 and S-UE3 123, as well as mandatory synchronization links, in certain embodiments, between S-UE2 122, S-UE1 121 and S-UE3 123.

The T-UE may transmit a request for positioning information to the network entity, such as location server 114. In certain embodiments, the request from the T-UE may include a desired position QoS level. The QoS level, for example, may be the maximum acceptable standard deviation of the position estimate. The request may also include a rough estimate of the T-UE position, and/or the status of the T-UE. The status may be an indication of the position precision that the T-UE may be able to achieve using its own measurements and algorithms. The status of the T-UE, for example, may be determined by a GNSS receiver or car sensors, such as a speedometer when the T-UE is a vehicle. The request transmitted by the T-UE may also include an indication of the behavior of the T-UE. The behavior, for example, may include an expected drive route or other information that allow for the dynamic tuning of the positioning and tracking of the T-UE by the network entity.

In other embodiments, the localization procedure can be initiated by the network entity, without having first received a request from the T-UE. Location server 114 may determine whether there is a need for S-UEs to help track the T-UE. The need for S-UEs may be determined based on the QoS requirement and/or a rough position estimate received from the T-UE, or based on a number of OTDOA-based positioning measurements evaluated at the LS. For at least one of the S-UEs associated with the T-UE, a network entity, such as LS 114, may activate and/or schedule a slot for S-PRS signal transmission from the S-UE. In some embodiments, the S-UE may be inactive until LS 114 chooses to activate the S-UE.

LS 114, in some embodiment, may then transmit or signal a request to a service BS. The request may ask the BS to allocate or schedule resources, such as SPS resources, for the S-UE, at which point the serving BS may allocate or schedule a slot for S-PRS transmission from the activated S-UE. The serving BS may also transmit an acknowledgment to LS 114, acknowledging the allocation of resources for the S-UE. In addition, in certain embodiment the parameters of the S-PRS signal may be communicated from the serving BS to the S-UE. For example, one parameter may allow multiple S-PRSs to be transmitted using the same time-frequency resources by different S-UEs.

The S-PRS, in certain embodiments, may be scheduled by LS 114 via semi-persistent scheduling (SPS), and sent over an available sidelink time or frequency resource to the T-UE. For example, the S-PRS may be transmitted in a Physical Uplink Shared Channel (PUSCH). LS 114 may determine at least one of the resources used for transmission of S-PRS, the time pattern for transmission of the S-PRS, and/or a transmission power used to transmit the S-PRS. The S-PRS may be either individually configured for a single T-UE, or configured for a group of T-UEs close to the respective S-UEs. For example, in FIG. 1, the S-PRS may be configured only for T-UE1, or the S-PRS may be configured for both T-UE1 and T-UE2.

The network entity, such as LS 114, may communicate to the T-UE a list of associated BSs and S-UEs. The T-UE may use the received information to detect the base station and/or the S-UEs. The information, also referred to as parameters, may include assigned S-PRS resources, PRS or S-PRS parameters for BS and/or S-UE signals respectively, time patterns, and/or geographic positions of BS and S-UEs. In certain embodiments, the positions of the BS and the S-UEs may be used by the T-UE to perform OTDOA measurements used to compute the T-UE's position itself. In certain embodiments, when the T-UE computes its own position estimate using OTDOA measurements, the T-UE may not share the measurements with LS 114 and instead only transmit the position estimate to LS 114.

In the example shown in FIG. 1, BSs 111, 112, and 113 may periodically transmit one or more PRS signals in the downlink direction to T-UE1 and T-UE2. LS 114 may determine the periodicity and/or timing pattern of the PRS signals transmitting to T-UE1 and T-UE2. In addition to the PRS signals, T-UE1 and T-UE2 may also receive S-PRS signals from S-UE1 121, S-UE2 122, and S-UE3 123. Using both the received PRS and S-PRS, the T-UE may perform an improved set of OTDOA measurements or an improved position estimate. In certain embodiments, the network entity, such as LS 114, may estimate the location of the T-UE. In such an embodiment, the T-UE may report to LS 114 the time-difference of arrival of the PRS signals and the S-PRS signals. Based on the received time-difference of arrival of the PRS signals and the S-PRS signals, LS 114 may perform a position estimate for the T-UE.

In some embodiments, LS 114 may update the list of base stations and/or S-UEs whose respective PRS and S-PRS may be measured by the T-UE. LS 114 may add, remove, or change the S-PRS or PRS scheduling. Once the list is updated, LS 114 may transmit the updated list to one, or more of the T-UEs, or all of them with a broadcast transmission.

The above embodiments may help to significantly improve the applicability of cellular-based positioning techniques. In one example, the embodiments may be used to improve existing protocols, such as the LTE positioning protocol (LPP). By allowing the T-UE to receive S-PRSs from S-UEs, the T-UE may take additional OTDOA measurements from points of transmission that are closer to the T-UE than the base stations. Doing so will decrease the GDOP, thereby increasing the accuracy of the positioning estimate of the T-UE.

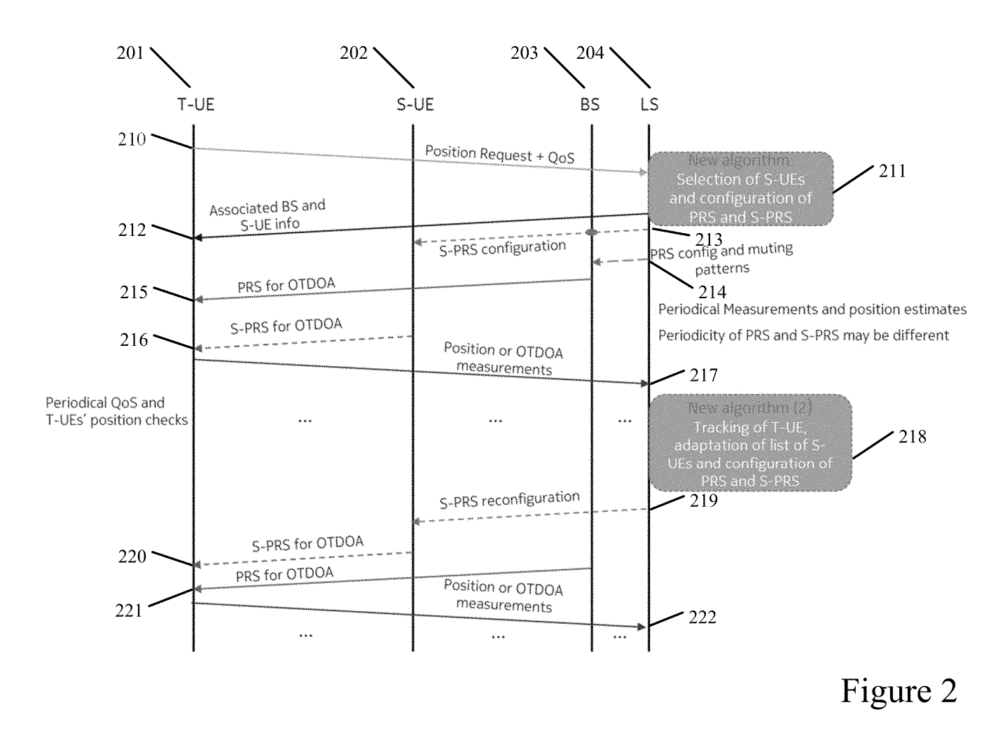

FIG. 2 illustrates an example of a signal flow diagram according to certain embodiments. In particular, FIG. 2 illustrates a messaging flow between T-UE 201, S-UE 202, BS 203, and LS 204. T-UE 201, S-UE 202, BS 203, and LS 204 may be similar to T-UE2, S-UE3 123, BS 113, and LS 114 shown in FIG. 1. While only one BS and S-UE are illustrated in FIG. 2, other embodiments may include more than one BS, more than one S-UE, and more than one T-UE, as shown in FIG. 1.

In step 210, T-UE 201, or an application running on T-UE, may transmit a request to LS 204 for positioning information. In the request, T-UE 201 may include a required QoS level for the positioning information. In other embodiments, step 210 may be skipped and LS 204 may proceed to step 211 without having received a request from T-UE 201.

In step 211, LS 204 may decide which S-UE should be activated, if any, and the associated BS may schedule resources for the S-UE in order to transmit the S-PRS. The resources, for example, may be SPS resources. The scheduled or assigned SPS resources may be exchanged between BS 203, S-UE 202, and T-UE 201. BS 203 may control the cell of the scheduled S-UE 202. LS 204 may also control the time patterns of the PRS to produce the OTDOA measurements from BS 203. In other words, LS 204 in step 211 may select S-UEs and configure the PRS and S-PRS transmitted from BS 203 and S-UE 202, respectively, to T-UE 201. In certain embodiments, a PRS or S-PRS pattern for the BS or the S-UE may be a time and/or frequency pattern of transmission from each BS or S-UE, as well as the parameter of the PRS or S-PRS transmitted from each BS or S-UE.

In step 212, LS 204 may share or transmit a list that comprises associated S-UEs and BSs to T-UE 201. In addition to the associated identities of the S-UEs and the BSs, the geographic positions of the S-UEs and the BS may also be included in the list. In certain embodiments, in step 212, LS 204 may also provide to T-UE 201 information related to the position of each BS and S-UE, such as BS 203 and S-UE 202, the synchronization links between all associated BSs and S-UEs, along with a confidence indication for when the T-UE determines a position estimation by itself. The confidence may be indicated, for example, via a confidence flag.

In certain embodiments, each BS or S-UE, such as BS 203 and S-UE 202, may share or transmit to the T-UE an index flag (IF), which groups together all nodes with the same reference time. All of the S-UEs, BSs, or any other node, having the same IF may be synchronized. In another embodiment, each BS or S-UE may share or transmit a confidence flag (CF), which indicates the precision of the synchronization of the specific BS, S-UE, or node. In certain embodiments, the CF may relate to the position of a specific BS, S-UE, or node. The CF, in one embodiment, may indicate a sampled standard deviation (SD) of the time of arrival measurement. For example, a CF=00 may mean an SD<1 nanoseconds (ns), a CF=01 may mean an SD<10 ns, a CF=10 may mean an SD<30 ns, and a CF=11 may mean an SD>30 ns. The information may be measured by the LS itself by observing previous transmissions, as well as considering the chosen PRS and S-PRS scheduling and configuration. In other embodiments, the information may be computed by the T-UE and shared with the LS using appropriate messages.

In steps 213 and 214, the network entity, such as the LS 204, may transmit or share with BS 203 and S-UE 202 information about the PRS or S-PRS. In step 213, the S-PRS configuration may be transmitted to S-UE 202. In step 214, the PRS configuration and/or muting pattern may be transmitted to BS 203. In certain embodiments, BS 203 or S-UE 202 may use a request-answer procedure to transmit a request to LS 204 for the configuration and/or the muting pattern of the PRS and S-PRS at any time. The configuration may include at least one of a transmission pattern and/or a transmission power of the PRS/S-PRS.

In step 215, T-UE 201 may receive at least one PRS, used to compute OTDOA measurements, from BS 203. In step 216, T-UE 201 may receive at least one S-PRS, used to compute OTDOA measurements, via a sidelink from S-UE 202. T-UE 201 may then perform at least one of an OTDOA measurement and/or a position estimate based on the received PRS and the S-PRS. In step 217, T-UE 201 may transmit the OTDOA measurement and/or the position estimate to LS 204. In another embodiment, the OTDOA measurement performed at T-UE 201 may be shared with LS 204, and T-UE 201 may demand the position and tracking of T-UE 201 from LS 204, or another cloud application. In other words, LS 204 may receive the OTDOA measurement, and determine the position estimation, also referred to as position estimate, of T-UE 201 based on the received OTDOA measurement. T-UE 201 may undergo periodic QoS checks and/or position estimation checks.

In step 218, LS 204 may track or estimate the position of T-UE 201 based on received OTDOA measurements. LS 204 may also determine to adjust or update the list of S-UEs and BSs from which the T-UE may receive the S-PRS and the PRS. In some embodiments, LS 204 may reconfigure or reschedule the PRS and/or the S-PRS. In step 219, LS 204 may transmit the S-PRS reconfiguration to S-UE 202. Periodic updates and/or reconfigurations may be shared between LS 204, and BS, 203, S-UE 202, and T-UE 201. In certain embodiments, an update may be triggered actively by a positioning application, which may be running on LS 204 or T-UE 201. The update may also be triggered by LS 204 itself, when the experienced QoS does not meet the desired QoS level indicated by T-UE 201.

In certain embodiments, LS 204 may update the list for each T-UE, with all the associated BSs and S-UEs, and their new PRS and S-PRS configuration. The updated list, and the associated BS and S-UE, may depend on a determining that a better QoS may be achieved based on the T-UE position or a predicted position in the future. LS 204 may also share an updated PRS and/or S-PRS pattern and/or transmitted power to one or more of the BS and S-UE. In certain embodiments, the updates may also include activating a new BS and/or S-UE, or putting some of the current BS and/or S-UE in sleep, idle, or mute mode when no T-UE may be around the BS and/or S-UE. In steps 220 and 221, T-UE 201 may receive S-PRS from S-UE 202 and PRS from BS 203. In step 222, T-UE 201 may transmit at least one of the OTDOA measurement or the position estimate to LS 204.

As shown in steps 211 and 218, LS 204 may schedule PRS and S-PRS patterns and transmit powers. In certain embodiments, the S-PRS transmitted via the sidelink may be transmitted in uplink resources. PRS and S-PRS may be orthogonal because they come at different time or frequency resources using Time Division Duplex (TDD) or Frequency Division Duplex (FDD), respectively.

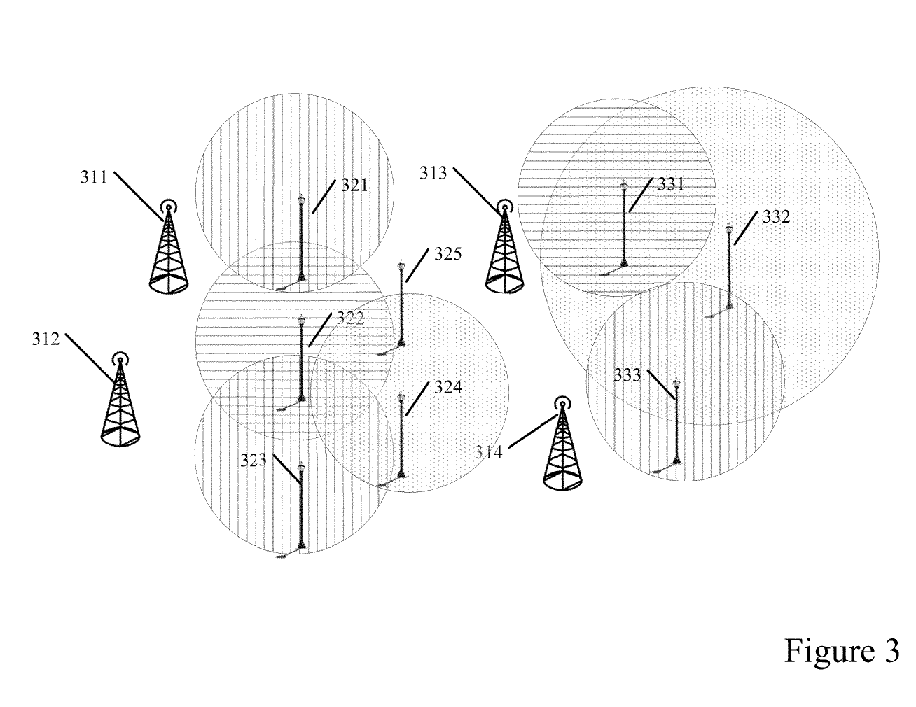

FIG. 3 illustrates an example of a diagram according to certain embodiments. In particular, FIG. 3 illustrates an example of a S-PRS scheduling decision in the same time-frequency resources, where only S-UEs are considered. FIG. 3 illustrates a system including base stations 311, 312, 313, and 314, and S-UEs 321, 322, 323, 324, 331, 332, and 333. The S-PRS may be transmitted with different powers using at least one of orthogonal sequences that can be scheduled on the same resources, different resource blocks, and/or different positions. In one example, there may be six possible S-PRS sequences.

As shown in FIG. 3, different S-UEs may be transmitting in the same time-frequency resources and/or with the same PRS/S-PRS parameters. While some S-UEs in FIG. 3, such as S-UE 321 and 323, may use the same S-PRS parameter, which may also be referred to as an index, the transmission powers are set so that the S-PRS transmissions do not interfere. In other words, S-UE 321 and S-UE 323 may use the same S-PRS sequence, but the transmission powers are set so that the S-PRS transmissions do not interfere with each other. The S-PRS index may represent an orthogonal signal used by the S-UEs to transmit the S-PRS. Some S-UEs, such as S-UE 325, may be muted in order to prevent any potential interference between S-UEs. While S-UE 321 and S-UE 323 use a first S-PRS index, S-UE 324 may use a second S-PRS index, and S-UE 322 may use a third S-PRS index. On the other hand, S-UE 331, S-UE 332, and S-UE 333 may all use different S-PRS index, while the transmission power of S-UE 332 may be greater than S-UE 331 and S-UE 333.

In certain embodiments, SPS resources may be allocated by a network entity, such as an LS, in the PUSCH every T milliseconds (ms), to handle these S-PRS transmissions. T may be a fixed time period determined by the LS, for example 50 ms. The S-PRS transmission may be the same as the PRS transmitted by the BS, with up to M different coexisting orthogonal sequences that can be allocated to an equal amount of M S-UEs. In LTE, for example, M may be equal to 6, and the periodicity of BS PRS transmission is 160 ms. The T value for S-PRS transmissions may be 160 ms, in some embodiments, but may be any other value, as determined by the network entity. In some embodiments, the transmissions of the PRS and S-PRS may be on different time scales. For example, PRS may be transmitted every 160 ms, while the S-PRS may be transmitted every 50 ms.

The PRS or S-PRS scheduling or planning may be an algorithm that may schedule BSs or S-UEs with the same PRS or S-PRS index in the same resource slot. In some embodiments, the algorithm may schedule BSs or S-UEs with same PRS or S-PRS index in the same resource slot when the BSs and S-UEs, are separated in space, and potentially tune the transmission power to ensure that the measurements have the desired reliability. When there may be a need of more than M transmissions, for example more than 6 transmissions, from S-UEs that are located near one another, the network entity may allocate more than one SPS resource slots dedicated to the S-PRS in the uplink.

The algorithm used by the network entity may make scheduling decisions for the S-PRS based on the desired QoS level. Once the scheduling decision is made, several scheduling decisions may be shared with each node, such as the BS or the S-UE. The network entity, for example, may provide a PRS or an S-PRS pattern to the BS or the S-UE. The PRS/S-PRS pattern may include the PRS index or signal identification that the BS or S-UE may transmit, as well as the muting pattern. A muting pattern is a signaling pattern that defines when the BS or the S-UE do not transmit the PRS or the S-PRS. In certain embodiments, it may be possible to schedule a single node for multiple PRS or S-PRS indices with different muting patterns. Multiple PRS or S-PRS indices with different muting patterns may be used by the PRS/S-PRS scheduler, such as the network entity or the LS, to reduce interference between different nodes, BSs, or S-UEs in all the locations of interest.

In some other embodiments, the network entity may send information relating to the transmission power to the BS and/or S-UEs. The information on the transmission power may be used by the BS and/or the S-UEs to transmit the PRS or S-PRS. Different transmission powers may be determined for each different PRS or S-PRS index or muting pattern.

In certain embodiments, the PRS or S-PRS scheduling may be transmitted or shared using a table. The rows of the table may correspond to a transmission on a certain PRS index with a given pattern and/or transmission power. Each row may carry information used to set up a periodical signal transmission, and each BS or S-UE may transmit signals based on all rows associated with the BS or S-UE. One row in the table may be a PRS or S-PRS index ranging from 0 to M−1, where M being the maximum PRS or S-PRS index possible. The PRS or S-PRS index may refer to the considered PRS or S-PRS among the M possible orthogonal PRSs or S-PRS sequences. In LTE DL PRS, for example, M may equal 6.

Another row in the table may be a periodicity value. The periodicity value corresponds to the periodic transmission of a PRS or S-PRS every T ms. In one embodiment T may equal 2^{P}·160 ms. P may be an integer ranging between 0 and 255 bits. In one example, P may be equal to 8 bits. 160 ms may correspond to the PRS or S-PRS minimum transmission period from the BS. A further row in the table may represent a time/frequency allocation. The information may be information related to the time/frequency allocation of a first transmission. The other transmissions, after the first transmission, may occur using the same resources, with the same index, at the periodicity T indicated in another row discussed above. In yet another row in the table, the PRS or S-PRS transmission power may be included.

In certain embodiments, the BS or S-UE may transmit PRS or S-PRS, respectively, in every allocated PRS or S-PRS slot. Multiple rows in the table may be associated to a user, allowing allocation of multiple PRS transmission from the same BS or S-UE, on different resources with different periodicity, or with two different PRS index/orthogonal signals in different resources.

While the S-PRS may be transmitted via the sidelink from the S-UE to T-UE using uplink resources, certain embodiments may allow the S-UEs to transmit the S-PRS in a downlink PRS resource reserved for the BS in the network. The transmission of the S-PRS in the downlink PRS resource reserved for the BS in the network may not be allowed in some embodiments. For example, a transmission of the S-PRS on the downlink PRS resource may not be allowed in a dense urban scenario.

In some embodiments, almost blank subframes (ABS) schemes, which allow for low powered transmissions in particular subframes, may be used to reduce interference in S-PRS. The S-PRS transmitted in the PUSCH may experience interference from one or more neighboring cells. Applying an ABS scheme may be used to help reduce this interference caused by the transmission of the S-PRS. ABS may allow the network central unit to coordinate different cells, and ask the interfering cells not to use the resources in the PUSCH in which the S-PRS may be transmitted.

In certain embodiments, an alternative signaling may be used for the S-PRS transmission. As shown in FIGS. 1 and 2, the BS transmits PRS signals, and S-UE transmits an S-PRS signal over uplink spectral resources. For 5G systems, a modified or enhanced PRS signal may be defined according to an NR standard. Similarly, the S-PRS may be based on this modified or enhanced PRS signal.

In some other embodiments, an unrelated signal may use the sidelink framework. For example, when the scheduled S-PRS or PRS transmission may occur over the entire bandwidth, a pseudo noise (PN) sequence may span the entire bandwidth, which may result in better time of arrival estimation performance compared to a LTE PRS-like signal. The PN sequence among different S-UEs may be designed to have favorable interference characteristics, for example using Gold sequences. Other options for the design of the S-PRS may be Walsh-Hadamard or Zadoff-Chu sequences.

The S-UEs may be synchronized to simultaneously transmit their S-PRS signal. As shown in FIG. 1, the S-UEs may be synchronized with the BSs, even though their respective S-PRS and PRS transmissions may not be simultaneous. Synchronizing S-UEs and BSs may allow for a single global time reference, and may make it possible to report the OTDOA measurements using a single reference framework. In some embodiments, only a single degree of freedom may be lost in the OTDOA measurements. Otherwise, when the S-UEs may not be synchronized with the BSs, two degrees of freedom may be lost since S-UE and BS OTDOA measurements may each require a reference. In other embodiments, more than two degrees of freedom may be lost, when the S-UEs are not globally synchronized, but instead synchronized in subsets.

The S-UEs may be synchronized using various options. For example, one option may be to use a GPS receiver, or a general GNSS receiver, at each S-UE so that the satellite signals may serve as a common reference. In embodiments in which BSs are typically synchronized using GNSS, the embodiments may result in a common reference for both the BSs and the S-UEs. In another embodiment, an over-the-air method may be used, in which S-UEs may each measure the timing of their S-PRS transmissions, and receive timing of S-PRSs transmitted from nearby S-UEs. These measurements may be sent to the LS which may then track the relative time offset of the S-UEs. Such embodiments may not be suitable when the S-UEs may not have a clear line-of-sight to allow for a reliable GNSS synchronization. In yet another embodiment, a network timing protocol may be used.

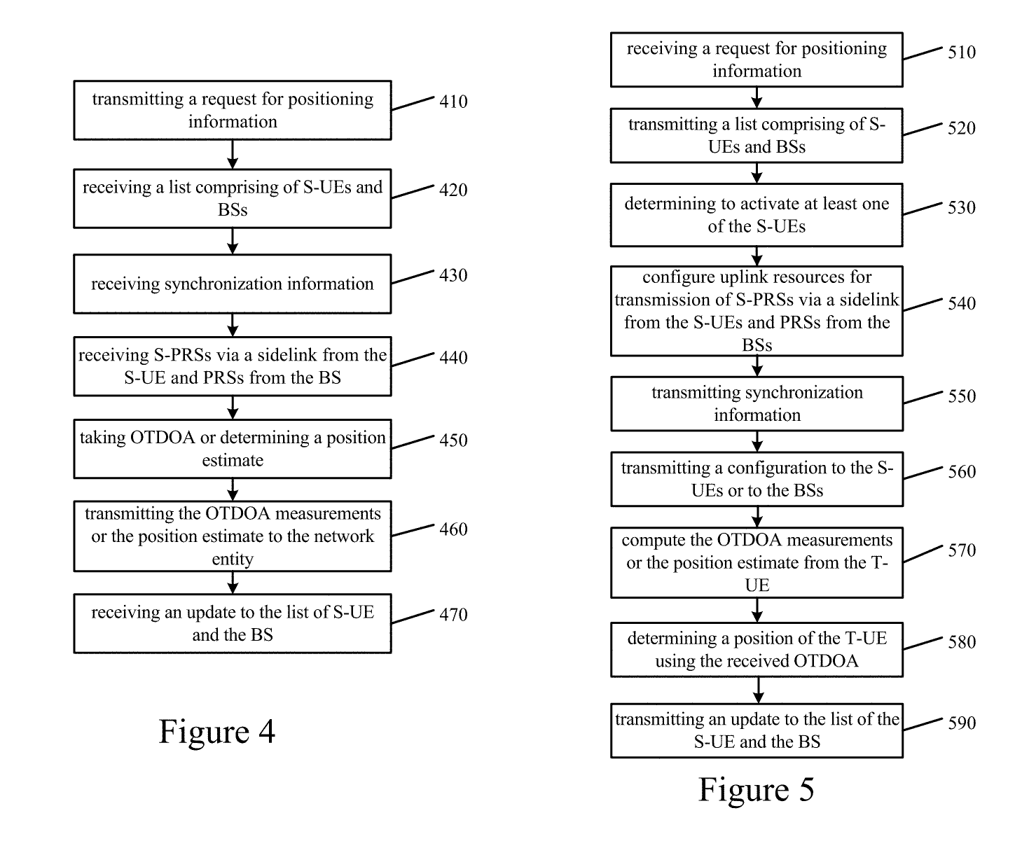

FIG. 4 illustrates an example of a flow diagram according to certain embodiments. In particular, FIG. 4 illustrates a method or process performed by T-UE. The T-UE may be a user device located in a vehicle or the vehicle itself. In step 410, the T-UE may transmit a request for positioning information to the network entity, such as LS 114 shown in FIG. 1. In step 420, T-UE may receive from the network entity a list comprising a plurality of S-UEs and a plurality of BSs. The S-UE may be static, and in some embodiments, may be closer to the T-UE than the BS. Closer may mean that the distance between the T-UE and the S-UE may be smaller than the distance between T-UE and the BS. In other words, the plurality of S-UEs provide better confidence in the OTDOA measurements than the OTDOA measurements from the plurality of BSs.

The T-UE may then receive synchronization information from the network entity, as shown in step 430. The synchronization information relates to synchronization between the plurality of BSs or the plurality of S-UEs. When more than one BS and more than one S-UE are included, the synchronization information may relate to synchronization of the BSs or the S-UEs themselves. In step 440, the T-UE may receive S-PRSs via sidelink transmission from the plurality of S-UEs and PRSs from the plurality of BS. The sidelink may be a device-to-device communication between the T-UE and the S-UE. The S-PRSs received via the sidelink from the S-UE may be received via an uplink resource, such as PUSCH. In another embodiment, however, the S-PRS may be transmitted in a downlink resource reserved for a PRS transmission from the BS.

In step 450, the T-UE may take OTDOA measurements or determine a position estimate based on the PRS and the S-PRS, and transmit the OTDOA measurement or the position estimate to the network entity, as shown in step 460. In step 470, the T-UE may receive an update to the list of the plurality of supporting S-UEs and the plurality of BSs.

FIG. 5 illustrates an example of a flow diagram according to certain embodiments. In particular, FIG. 5 illustrates a method or process being performed by a network entity, such as the LS shown in FIGS. 1 and 2. The network entity described in FIG. 5 may communicate with the T-UE described in FIG. 4. In step 510, the request for positioning information may be received at the network entity from the T-UE. The request for positioning information may include an associated quality of service information. In step 520, the network entity may transmit to a T-UE a list comprising of a plurality of S-UEs and a plurality of BSs. The network entity, in some embodiments, may determine to activate at least one of the S-UEs, as shown in step 530, and may request the BS to schedule resources for the S-UEs. In such embodiments, the S-UE may belong to a cell controlled by the BS.

In step 540, the network entity may schedule, or cause to be configured, uplink resources for transmission of S-PRSs via a sidelink by the plurality of the S-UEs and downlink resources for transmission of PRSs by the plurality of BSs. For example, the network entity may trigger the BS to schedule or allocate resources for S-PRS. In certain embodiments, the network entity may share a table that includes the configured resources with at least one of the BS or the S-UE. In some embodiments, the LS may coordinate signaling in order to avoid transmission of S-PRS on the same frequencies and/or index from two potentially interfering S-UEs. In other words, the LS may request SPS resources to the serving BS of the S-UEs. The LS may then allocate the indexes according to the S-PRS scheduling algorithm. The BS may send a resource grant, for example an SPS resource grant, to the S-UE, as well as an indication of the position of the grant in the time and/or frequency resources. The BS or LS may share with each S-UE the index of the orthogonal S-PRS to be transmitted.

In step 550, synchronization information may be transmitted from the network entity to the T-UE. The synchronization information relates to synchronization between the BS and/or the S-UE. In step 560, the network entity may transmit a configuration to the S-UE or to the BS. In one embodiment, the network entity may transmit a reconfiguration for the S-PRS to the S-UE or a reconfiguration of the PRS to the BS. In some embodiments, the configuration may be transmitted before the network entity receives the OTDOA measurements from the T-UE, and the reconfiguration may be transmitted after the network entity receives the OTDOA measurements from the T-UE. The transmitting of the configuration or reconfiguration may include at least one of a transmission pattern or a transmission power for the PRS or S-PRS. In another embodiment, the network entity may transmit at least one of a muting pattern for the PRS to the BS. The transmitting of the configuration may include at least one of a transmission pattern or a transmission power for the PRS or the S-PRS.

In step 570, the network entity may compute at least one of an OTDOA measurement or a position estimate from the T-UE. The OTDOA measurement or the position estimate may be based on the plurality of S-PRSs and the plurality of PRSs. In certain embodiments, the T-UE may determine a position of the T-UE using the received OTDOA measurement, as shown in step 580. In step 590, the network entity may transmit an update to the list including the S-UE and the BS to the T-UE.

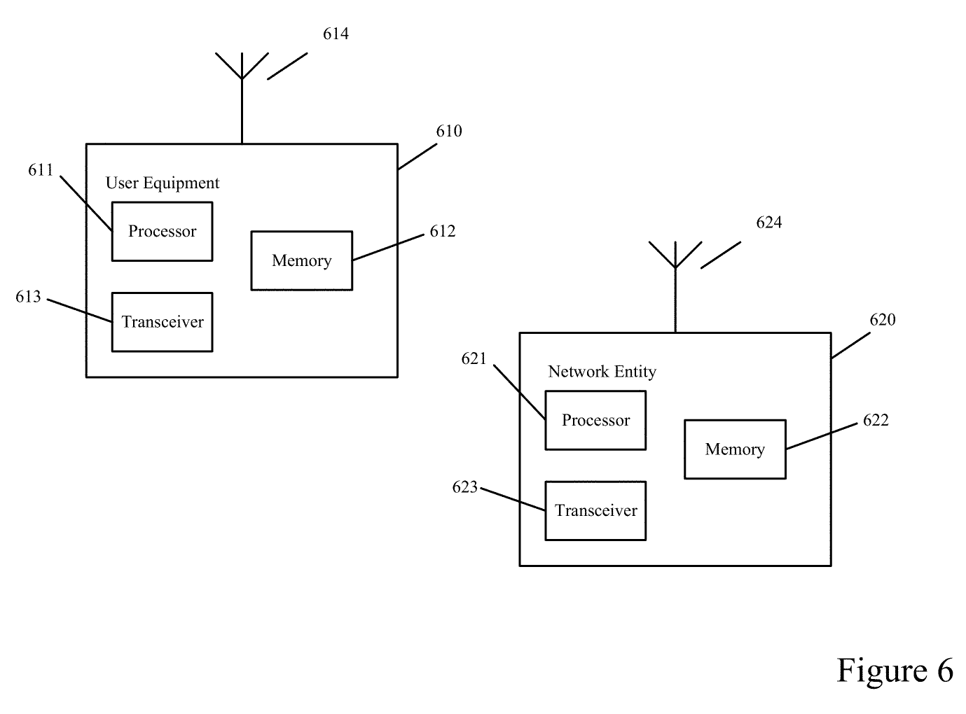

FIG. 6 illustrates an example of a system according to certain embodiments. It should be understood that each block in FIGS. 1-5 may be implemented by various means or their combinations, such as hardware, software, firmware, one or more processors and/or circuitry. In one embodiment, a system may include several devices, such as, for example, a network entity 620 or a UE 610. The system may include more than one UE 610 and more one network entity 620, although only one network entity is shown for the purposes of illustration. The network entity may be a network node, an access node, a base station, a location server, an evolved NodeB (eNB), a 5G or NR NodeB (gNB), a host, any other server, or any of the other access or network node discussed herein.

Each of these devices may include at least one processor or control unit or module, respectively indicated as 611 and 621. At least one memory may be provided in each device, and indicated as 612 and 622, respectively. The memory may include computer program instructions or computer code contained therein. One or more transceiver 613 and 623 may be provided, and each device may also include an antenna, respectively illustrated as 614 and 624. Although only one antenna each is shown, many antennas and multiple antenna elements may be provided to each of the devices. Higher category UEs generally include multiple antenna panels. Other configurations of these devices, for example, may be provided. For example, network entity 620 and UE 610 may be additionally configured for wired communication, in addition to wireless communication, and in such a case antennas 614 and 624 may illustrate any form of communication hardware, without being limited to merely an antenna.

Transceivers 613 and 623 may each, independently, be a transmitter, a receiver, or both a transmitter and a receiver, or a unit or device that may be configured both for transmission and reception. In other embodiments, the network entity may have at least one separate receiver or transmitter. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network node deliver local content. One or more functionalities may also be implemented as virtual application(s) in software that can run on a server.

A user device or user equipment may be a supporting user equipment or a target user equipment. A user device or user equipment may also be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The target user equipment may, in some embodiments, be included within a traveling vehicle or may be the vehicle itself. In other embodiments, the supporting UE, and in some embodiments the target UE, may be a machine type communication (MTC) device, an eMTC UE, or an Internet of Things device, which may not require human interaction, such as a sensor, a meter, an actuator. The sensor, meter, or actuator may be included in a static casing or apparatus, such as a street lamp, traffic light, parking meter, or stop sign.

In some embodiments, an apparatus, such as user equipment 610 or network entity 620, may include means for performing or carrying out embodiments described above in relation to FIGS. 1-5. In certain embodiments, the apparatus may include at least one memory including computer program code and at least one processor. The at least one memory including computer program code can be configured to, with the at least one processor, cause the apparatus at least to perform any of the processes described herein. The apparatus, for example, may be user equipment 610 or network entity 620.

Processors 611 and 621 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 612 and 622 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network entity 620 or UE 610, to perform any of the processes described above (see, for example, FIGS. 1-5). Therefore, in certain embodiments, a non-transitory computer-readable medium may be encoded with computer instructions or one or more computer program (such as added or updated software routine, applet or macro) that, when executed in hardware, may perform a process such as one of the processes described herein. In other embodiments, a computer program product may encode instructions for performing any of the processes described above, or a computer program product embodied in a non-transitory computer-readable medium and encoding instructions that, when executed in hardware, perform any of the processes describes above. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

In certain embodiments, an apparatus may include circuitry configured to perform any of the processes or functions illustrated in FIGS. 1-5. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

Specific examples of circuitry may be content coding circuitry, content decoding circuitry, processing circuitry, image generation circuitry, data analysis circuitry, or discrete circuitry. The term circuitry may also be, for example, a baseband integrated circuit or processor integrated circuit for a mobile device, a network entity, or a similar integrated circuit in server, a cellular network device, or other computing or network device.

Furthermore, although FIG. 6 illustrates a system including a network entity 620 and UE 610, certain embodiments may be applicable to other configurations, and configurations involving additional elements, as illustrated and discussed herein. For example, multiple user equipment devices and multiple network entities may be present, or other nodes providing similar functionality, such as nodes that combine the functionality of a user equipment and an network entity, such as a relay node. The UE 610 may likewise be provided with a variety of configurations for communication other than communication network entity 620. For example, the UE 610 may be configured for device-to-device, machine-to-machine, and/or vehicle-to-vehicle transmissions.

The above embodiments may provide for significant improvements to the functioning of a network and/or to the functioning of the user equipment and the network entities included within the network. Certain embodiments may help to improve the accuracy of the position estimation of the T-UE. The improvement may be, in part, helped by the use of S-PRS transmissions via sidelink from the S-UEs. Utilizing S-PRS transmissions may help to increase the number of meaningful OTDOA measurements at the T-UE, thereby minimizing the GDOP of the T-UE. These embodiments may therefore help to improve the accuracy of the position estimation of the T-UE, while also helping to ensure that the position estimation maintains an adequate QoS level.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

Partial Glossary

ABS Almost Blank Subframe

BS Base Station

GDOP Geometrical Dilution of Precision

gNB 5G Base Station

GNSS Global Navigation Satellite Systems

GPS Global Positioning System

LPP LTE Positioning Protocol

LS Location Server

NR New Radio

OTDOA Observed Time Difference of Arrivals

PRS Positioning Reference Signal

PUSCH Physical Uplink Shared Channel

RAT Radio Access Technology

RSU Road Side Unit

SPS Semi Persistent Scheduling

S-PRS Supporting Positioning Reference Signals

S-UE Supporting UE

T-UE Target UE

UE User Equipment

UL Uplink

VRU Vulnerable Road Users

1. A method comprising:
receiving, at a target user equipment from a location control network entity, a list comprising a plurality of supporting user equipment and a plurality of base stations;
receiving, at the target user equipment, a single supporting positioning reference signal via sidelink transmission from each supporting user equipment of the plurality of supporting user equipment and positioning reference signals from the plurality of base stations of the received list; and
taking observed time difference of arrival measurements or determining a position estimate at the target user equipment based on the positioning reference signals and the supporting positioning reference signals.

2. The method according to claim 1, further comprising:
transmitting a request for positioning information from the target user equipment to the network entity, wherein the request includes an associated quality of service information.

3. The method according to claim 1, further comprising:
receiving synchronization information from the network entity, wherein the synchronization information relates to synchronization between the plurality of base stations or the plurality of supporting user equipment.

4. The method according to claim 1, further comprising:
receiving at the target user equipment an update to the list of the plurality of supporting user equipment and the plurality of base stations from the network entity.

5. The method according to claim 1, wherein the supporting positioning reference signals received via the sidelink from the plurality of supporting user equipment are received on uplink resources.

6. The method according to claim 1, wherein the plurality of supporting user equipment are static.

7. The method according to claim 1, wherein the plurality of supporting user equipment provide better confidence in the observed time difference of arrival measurements than the observed time difference of arrival measurements from the plurality of base stations.

8. The method according to claim 1, further comprising:
transmitting the taken observed time difference of arrival measurements or the determined position estimate from the target user equipment to the network entity.

9. A method comprising:
transmitting, from a location control network entity to a target user equipment, a list comprising a plurality of supporting user equipment and a plurality of base stations;
scheduling uplink resources for transmission of a single supporting positioning reference signal via sidelink transmission by each user equipment of the plurality of supporting user equipment and transmission of positioning reference signals by the plurality of base stations of the received list; and
computing, at the network entity, observed time difference of arrival measurements or a position estimate from the target user equipment, wherein the observed time difference of arrival measurements or the position estimate are based on the supporting positioning reference signals and the positioning reference signals.

10. The method according to claim 9, further comprising:
receiving a request for positioning information at the network entity from the target user equipment, wherein the request includes an associated quality of service information.

11. The method according to claim 9, further comprising:
determining to activate at least one of the plurality of supporting user equipment; and
requesting the at least one of the plurality of base stations to schedule resources for the at least one of the plurality of supporting user equipment.

12. The method according to claim 9, further comprising:
transmitting synchronization information from the network entity to the target user equipment, wherein the synchronization information relates to synchronization between the plurality of base stations or the plurality of supporting user equipment.

13. The method according to claim 9, further comprising:
transmitting a configuration or a reconfiguration for the supporting positioning reference signals from the network entity to the plurality of supporting user equipment.

14. The method according to claim 13, wherein the transmitting of the configuration or reconfiguration comprises at least one of a transmission pattern or a transmission power for the supporting positioning reference signals.

15. The method according to claim 9, further comprising:
transmitting at least one of a configuration or a muting pattern for the positioning reference signals from the network entity to the plurality of base stations.

16. The method according to claim 15, wherein the transmitting of the configuration comprises at least one of a transmission pattern or a transmission power for the positioning reference signals.

17. The method according to claim 9, further comprising:
transmitting an update to the list of the plurality of supporting user equipment and the plurality of base station from the network entity to the target user equipment.

18. The method according to claim 9, further comprising:
sharing a table including the scheduled uplink resources with at least one of the plurality of base stations or the plurality of supporting user equipment.

19. The method according to claim 9, further comprising:
determining a position of the target user equipment using the received observed time difference of arrival measurement.

20. An apparatus comprising:
at least one processor;
at least one memory comprising computer program code,
wherein the at least one memory and the computer program code are configured, with the at least one processor, to cause the apparatus at least to:
receive, from a location control network entity, a list comprising a plurality of supporting user equipment and a plurality of base stations;
receive a single supporting positioning reference signal via sidelink transmission from each supporting user equipment of the plurality of supporting user equipment and positioning reference signals from the plurality of base stations of the received list; and
take observed time difference of arrival measurements or determine a position estimate based on the positioning reference signals and the supporting positioning reference signals.
